(19) United States
(12) Patent Application Publication
(10) Pub. No.: US 2021/0035029 A1
(43) Pub. Date: Feb. 4, 2021

(54) DYNAMICALLY UPDATING AN AUTOMATED LUGGAGE HANDLING SYSTEM BASED ON CHANGING RESERVATIONS

(71) Applicant: International Business Machines Corporation, Armonk, NY (US)

(72) Inventors: Roman Vaculin, Larchmont, NY (US); Heena Bansal, Bangalore (IN); Seema Nagar, Bangalore (IN); Kuntal Dey, New Delhi (IN)

(21) Appl. No.: 16/528,127

(22) Filed: Jul. 31, 2019

(51) Int. Cl. G06Q 10/02; G06Q 50/30; G06N 20/00

(52) U.S. Cl. CPC G06Q 10/02; G06N 20/00; G06Q 50/30

(57) ABSTRACT

A flight ticket transfer system obtains an identification of a traveler and of an earlier booked flight, provides a listing of earlier departing flights, receives a selection of an earlier departing flight from among the listing of the earlier departing flights, identifies an earlier departing booked airline corresponding to the earlier departing booked flight, and sends to the earlier departing booked airline a flight luggage request, receives from a transfer feasibility module a success response to the luggage request, relative to an estimated time for transfer of the traveler's luggage from the earlier booked flight to the selected earlier departing flight, and completes a purchase of a ticket for the selected earlier departing flight.

### BACKGROUND

The present invention relates to the electrical, electronic, and computer arts, and more specifically, to computer systems for managing airline ticketing and luggage transfers.

Airlines sometimes offer “standby” tickets to travelers when seats become unexpectedly vacant. These standby tickets represent an opportunity for travelers to, for example, reach their destination earlier, to have an upgraded seat, etc. For the airline, the standby ticket represents an opportunity to increase profitability by maximizing a number of customers. Whether a given traveler can take advantage of a standby ticket can be dependent on a number of factors, at least some of which are system dependent and difficult to gauge.

### SUMMARY

Principles of the invention provide techniques for dynamically updating a baggage handling system based on changes in a flight reservation to an earlier departing flight. In one aspect, an exemplary method includes obtaining from a traveler an identification of the traveler and of an earlier booked flight; providing to the traveler a listing of earlier departing flights; receiving from the traveler a selection of an earlier departing flight; identifying an earlier booked airline corresponding to the earlier booked flight, and sending to the earlier booked airline a luggage request; receiving from a transfer feasibility module a success response to the luggage request, relative to an estimated time for transfer of the traveler's luggage from the earlier booked flight to the selected earlier departing flight; and completing a purchase for the traveler of a ticket for the selected earlier departing flight.

In another aspect, an exemplary method includes receiving from an airline ticket transfer system, at a central reservations system of a selected airline, a flight request that includes a traveler's identification, an earlier departing flight number of the selected airline, and the traveler's earlier booked flight number; identifying, in the central reservations system of the selected airline, an earlier booked airline based on the earlier booked flight number, and sending to a luggage handling system of the earlier booked airline a first luggage transfer time request that includes the traveler's identification and the traveler's earlier booked flight number; receiving from the luggage handling system of the earlier booked airline an estimate of a first partial transfer time for transferring the traveler's luggage from its location in the earlier booked airline's luggage system to a luggage drop point of the selected airline; sending to a luggage handling system of the selected airline a second luggage transfer time request that includes the traveler's identification and the earlier departing flight number; receiving from the luggage handling system of the selected airline a second partial transfer time to transfer the traveler's luggage from the luggage drop point of the selected airline to a luggage chamber of an earlier departing flight; obtaining a completed transfer time based on a sum of the first and second partial transfer times with a current time; and, in response to the completed transfer time being earlier than a boarding time of the earlier departing flight, delivering a success message to the transfer system.

In yet another aspect, an exemplary method includes obtaining from a luggage handling system of a first airline, for a flight ticket transfer transaction, an estimate of a first partial transfer time for transferring a traveler's luggage from its location in a luggage queue of the first airline to a luggage drop point of a second airline; obtaining from a luggage handling system of the second airline an estimate of a second partial transfer time for transferring the traveler's luggage from the second airline's luggage drop point to a luggage chamber of an earlier departing flight; estimating an estimated completed transfer time by summing with a current time the estimates of the first and second partial transfer times; obtaining from a transfer transactions database an actual completed transfer time for the flight ticket transfer transaction; and training a machine learning module to estimate another completed transfer time for another flight ticket transfer transaction, based on comparing the actual completed transfer time to the estimated completed transfer time.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory that embodies computer executable instructions, and at least one processor that is coupled to the memory and operative by the instructions to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a tangible computer readable storage medium (or multiple such media) and implemented on a hardware processor, or (iii) a combination of (i) and (ii); any of (i)-(iii) implement the specific techniques set forth herein.

In view of the foregoing, techniques of the present invention can provide substantial beneficial technical effects. For example, one or more embodiments provide one or more of:

Intelligent collection of data and determination of the feasibility of updating destination information for luggage in a system from an earlier booked flight to an earlier departing flight;

Pre-purchase validation of a standby ticket purchase with reference to pre-existing checked luggage; and

Automated recommendation of feasible earlier departing flights in response to checked luggage for an earlier booked flight.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIGS. 3A-3B depict a system architecture for implementing a method of dynamically moving a flight ticket to an earlier departing flight, according to an exemplary embodiment;

FIGS. 4A-4C depict another system architecture for implementing another method of dynamically moving a flight ticket to an earlier departing flight, according to another exemplary embodiment; and

FIG. 5 depicts a computer system that may be useful in implementing one or more aspects and/or elements of the invention.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

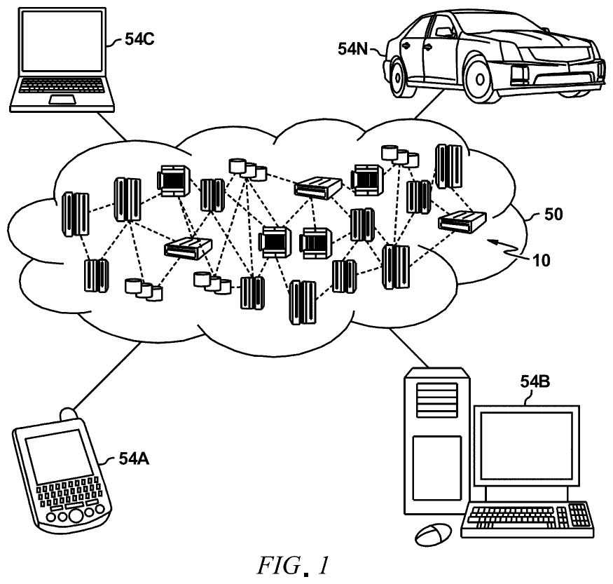

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

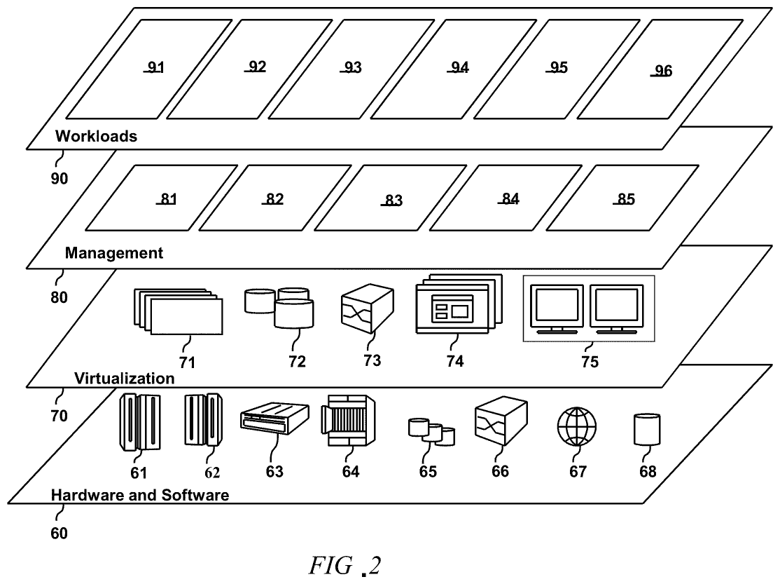

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a system 96 for dynamically updating a baggage handling system.

In many conventional scenarios, a traveler books a flight reservation (an “earlier booked flight”), arrives at the appropriate airport, and checks one or more pieces of luggage with an airline providing transit. In some cases, the traveler may realize after the luggage has been checked for the earlier booked flight that it is possible to board a different flight that leaves earlier (an “earlier departing flight”) than the earlier booked flight. In these cases, the traveler may want to buy a standby ticket for the earlier departing flight and update destination information for their luggage from the earlier booked flight to the earlier departing flight. However, it is not known to the traveler whether the luggage can be feasibly transferred to the earlier departing flight in time for the flight.

It will be appreciated that one challenge in purchasing a standby ticket for an earlier departing flight, given that a traveler already has checked their luggage for an earlier booked flight, is that the luggage may not be transferred to the earlier departing flight from a luggage handling system associated with the earlier booked flight, in which case the traveler may be separated from their luggage, either at an origin airport or a destination airport. Further, in some cases, unaccompanied luggage may be removed to a secure area for holding and/or disposal if its owner is separated from the luggage (e.g., the traveler and the luggage are on different flights). In such cases, the traveler taking the earlier departing flight without their luggage may be required to track the location of their luggage, and may need to wait for later arrival of the luggage. In other scenarios, unaccompanied luggage can lead to delayed or diverted flights, since in at least some cases airlines are not permitted to knowingly transport luggage without its owner across international borders.

Aspects of the invention overcome this challenge by determining, before completing the purchase of a standby ticket for an earlier departing flight, the feasibility of updating destination information for the traveler's checked luggage from an earlier booked flight to an earlier departing flight (e.g., before the earlier departing flight finishes boarding and/or loading). In one or more embodiments, a luggage handling system uses smart tags or bar codes on the luggage to determine the location of the luggage, which in turn informs a transfer feasibility module's determination about whether it is feasible to update destination information for the luggage within the context of the luggage handling system to successfully transfer the luggage from one flight to another. In one or more embodiments, the transfer feasibility module includes machine learning software that learns the time required to transfer luggage from a first flight to a second flight considering factors such as a location of traveler's luggage in the first flight's luggage queue or luggage chamber, time of the day, crowd in the airport, location of the luggage chambers for both flights, etc. According to some embodiments, a backend server or cloud-hosted system hosts the transfer system and the transfer feasibility protocol. One or more embodiments include an application/browser-based transfer system by which the traveler can input their earlier booked flight number and can receive offers for earlier departing flights from one or more airlines. In one or more embodiments, the transfer system pre-qualifies the offers based on a specifically determined feasibility of transferring the traveler's checked luggage.

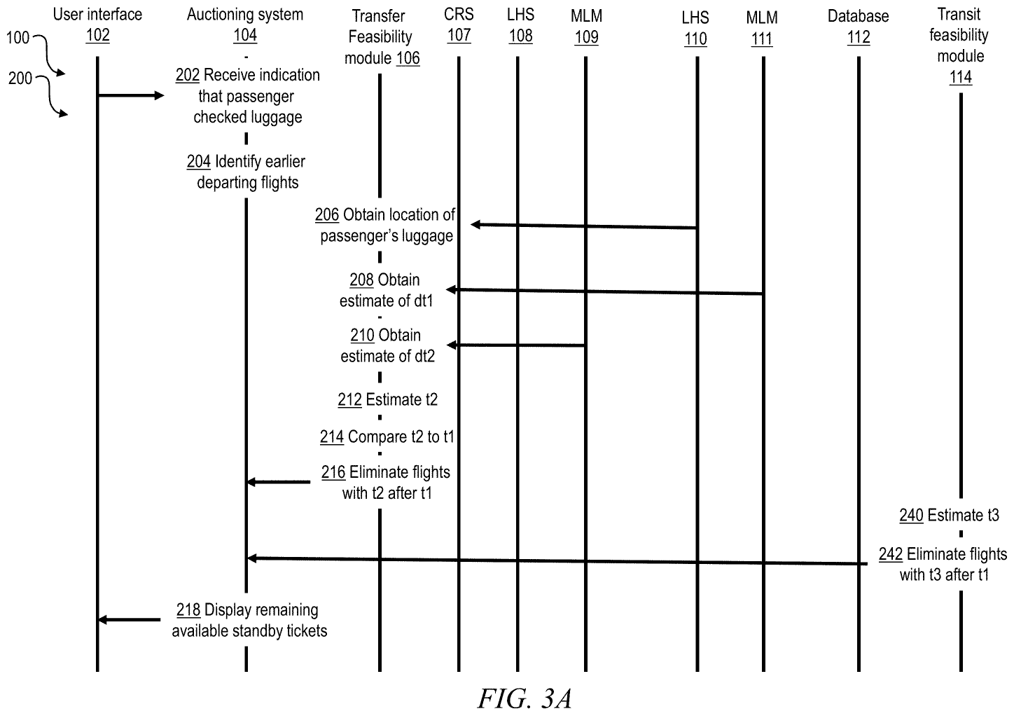

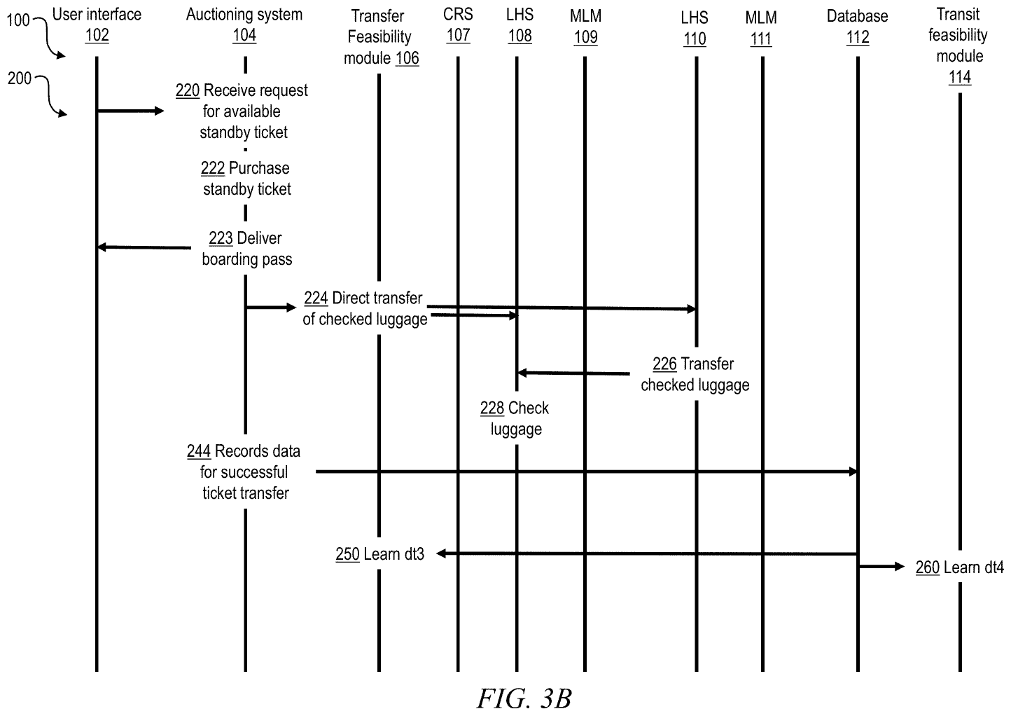

Accordingly, FIGS. 3A-3B depict a system architecture 100 for implementing the system 96 according to a method 200 of dynamically moving a flight ticket to an earlier departing flight. The system architecture 100 includes a user interface 102, an transfer system 104, a machine-learning-based transfer feasibility module 106, an earlier departing airline's central reservations system (CRS) 107, luggage handling system (LHS) 108, and associated machine learning module (MLM) 109, an earlier booked airline's LHS 110 and associated MLM 111, and a transfer transactions database 112. According to certain embodiments, the architecture 100 also includes a transit feasibility module 114, which is separate and distinct from the transfer feasibility module 106. In one or more embodiments, the transfer system 104, the transfer feasibility module 106, and the transit feasibility module 114 are implemented separately from any airline's central reservations system or luggage handling system. For example, any or all of these modules may be implemented in the cloud or on in-airport backend servers.

The method 200 includes at 202 the transfer system 104 receiving, via the user interface 102, an indication that a traveler has checked their luggage for an earlier booked flight and wants to find a standby ticket for an earlier departing flight. In one or more embodiments, the indication includes the traveler's earlier booked flight number and the traveler's identification (e.g., name and flight number). Then at 204 the transfer system 104 identifies earlier departing flights with scheduled boarding times between the time that the traveler checked their luggage and a boarding time of the earlier booked flight. For example, the transfer system 104 identifies the earlier departing flights based on published information such as an electronic flight board. In one or more embodiments, the transfer system 104 can make use of optical character recognition (OCR) on a video feed obtained from a camera directed toward a video flight time display in an airport terminal.

At 206, the transfer feasibility module 106 obtains from the earlier booked airline's LHS 110 a location of the traveler's luggage in the earlier booked flight's luggage queue (i.e. the pathway from the earlier booked flight's check in counter to the earlier booked flight's on aircraft luggage chamber). At 208, the transfer feasibility module 106 obtains from the earlier booked airline's LHS 110 an estimate for each earlier departing flight of a unique first partial transfer time dt1 by which the traveler's luggage can be moved from the earlier booked flight's luggage queue to the earlier departing airline's check in counter. At 210, the transfer feasibility module 106 then obtains from the earlier departing airline's LHS 108 an estimate for each earlier departing flight of a unique second partial transfer time dt2 by which the traveler's luggage can be moved from the earlier departing airline's check in counter to the earlier departing flight's luggage chamber. In one or more embodiments, the estimates of partial transfer times dt2, dt1 can be obtained from machine learning modules 109, 111 in the respective LHSs 108, 110. In one or more embodiments, the machine learning modules 109, 111 can be trained as further discussed below. At 212, the transfer feasibility module 106 adds up the first and second partial transfer times dt1, dt2 and adds the result to a current time t in order to estimate a completed transfer time t2 for each earlier departing flight. In one or more embodiments, the estimates of partial transfer times dt1, dt2 and of complete transfer time t2 are updated in real time as the earlier booked airline's LHS 110 reports movement of the traveler's luggage through the earlier booked flight's luggage queue. During this time, the traveler may decide to request an earlier departing flight.

At 214, the transfer feasibility module 106 compares the complete transfer time t2 for each of the earlier departing flights to a gate closed time t1 for each flight. At 216, the transfer feasibility module 106 eliminates any earlier departing flights that have complete transfer times t2 that come after the gate closed time(s) t1 for those flight(s) to finish boarding.

At 218, the transfer system 104 displays to the traveler, by activating the user interface 102, remaining available standby tickets for earlier departing flights that have estimated complete transfer times t2 before the gate closed times t1 at which the flight(s) are scheduled to finish boarding. At 220, the transfer system 104 receives from the traveler, via the user interface 102, a request for one of the available standby tickets. At 222, the transfer system 104 purchases the requested ticket for the traveler and at 223 the transfer system 104 delivers a boarding pass to the traveler via the user interface 102. At 224, the transfer system 104 communicates with the transfer feasibility module 106, which directs the earlier booked airline's LHS 110 to transfer the traveler's checked luggage from the earlier booked flight's luggage queue to the earlier departing flight's gate or to the earlier departing airline's counter. In one or more embodiments, the LHS 110 responds by rejecting the traveler's checked luggage with a message to transfer it to the LHS 108.

At 226, the LHS 110 transfers the traveler's checked luggage to the earlier departing flight's gate or to the earlier departing airline's luggage drop point. Note that the LHS 110 can be wholly or partially automated, or can be entirely manual aside from computer indications of luggage destinations. At 228, the earlier departing airline's LHS 108 checks the traveler's luggage for the earlier departing flight. This can be a gate check or a counter check.

In one or more embodiments, the LHS 108, 110 locate luggage by use of “smart tags” attached to the luggage. “Smart tags” are RFID devices that identify each item of luggage and its owner by unique codes. In other embodiments, the LHS 108, 110 locate luggage by maintaining records of checkpoints where paper tags with luggage bar codes have been scanned with a barcode reader. For example, luggage handling personnel may scan paper tags with a handheld barcode reader before passing the luggage through a security scanner, after receiving the luggage from the security scanner and loading it onto a conveyor or tractor cart (in which case the personnel also would scan a barcode of the tractor cart or conveyor in order to record where the luggage was), when unloading the luggage from a tractor cart or conveyor at a first stop (in which case the personnel also would scan a barcode of the first stop), etc. The earlier booked airline's LHS 110, according to one or more embodiments of the invention, is capable of reading smart tags to locate luggage within a luggage queue, at one or more points inclusive between check in counter (or other luggage drop point) and luggage chamber. Indeed, in one or more embodiments the LHS 110 is capable of locating luggage within an aircraft's luggage chamber by scanning for the smart tag(s) attached to the luggage.

In one or more embodiments, the LHS 110 makes use of the smart tag luggage location for estimating the partial transfer time dt1 for each item of luggage and each earlier departing flight. For example, if an item of luggage is in an earlier booked flight's luggage queue in transit from the check in counter to a security checkpoint in Terminal A, while a first earlier departing flight is at the gate in Terminal C, then the LHS 110 will estimate a greater partial transfer time for the first earlier departing flight compared to a lesser partial transfer time for a second earlier departing flight that is at the gate in Terminal A.

As mentioned above, estimates of the partial transfer times dt2, dt1 can be obtained from respective machine learning modules 109, 111 that are associated with respective LHSs 108, 110. In one or more embodiments, each machine learning module (MLM) is trained on “big data” from the transfer transactions database 112. For example, each time a luggage transfer is completed, the MLM 111 that is associated with the LHS 110 obtains from the transfer transactions database 112 an actual time for transferring the luggage from its location in the LHS 110 luggage queue to a luggage drop point of the LHS 108. The MLM 111 compares the actual time to the previously estimated partial transfer time dt1, and updates the weights of its neural network to bring the estimate of partial transfer time closer to the actual time while keeping other estimated partial transfer times also close to the corresponding actual times. Furthermore, in one or more embodiments, the MLM 109 that is associated with the LHS 108 obtains from the transfer transactions database 112 an actual time for transferring the luggage from the counter or other luggage drop point of the LHS 108 to the luggage chamber of the earlier departing flight. The MLM 109 compares the actual time to the previously estimated partial transfer time dt2, and updates the weights of its neural network to bring the estimate of partial transfer time closer to the actual time while keeping other estimated partial transfer times also close to the corresponding actual times. Thus, after sufficient repetitions of luggage transfers, each of the MLMs 109, 111 will converge to a model for partial luggage transfer time that predicts the partial transfer time for any given luggage transfer with a satisfactory level of confidence. Further, the machine-learning-based transfer feasibility module 106 can obtain from the transfer transactions database 112 a history of actual completed transfer times compared to estimated completed transfer times t2, and can thereby train itself to provide accurate estimates of t2 without relying on the subsidiary MLMs 109, 111.

Another issue that may arise in booking an earlier departing flight is whether the traveler will be able to reach the gate for the earlier departing flight before the flight begins/completes boarding. This is a separate consideration from whether the traveler's luggage can get into the earlier departing flight's luggage chamber. However, similar principles apply.

Accordingly, in one or more embodiments at 240 a transit feasibility module 114—distinct from the transfer feasibility module 106—can estimate the traveler's transit time t3 to arrive at the gate for an earlier departing flight from the traveler's present location. For example, if an earlier departing flight is at the gate in Terminal A, while the traveler is outside the security checkpoint for Terminal A, the transit feasibility module 114 can estimate an earlier transit time t3 for the earlier departing flight compared to a later transit time t3 for the same earlier departing flight if the traveler is inside the security checkpoint at Terminal B. Similar to the complete transfer time(s) t2, the transit time(s) t3 can be updated in real-time based on the traveler's location, which can be detected using, e.g., wireless signal tracking or Global Positioning tracking on the mobile device that the traveler uses to access the user interface 102.

In embodiments that consider traveler transit time(s) t3, at 242 the transit feasibility module 114 eliminates any earlier departing flight(s) that have transit time(s) t3 after time(s) t1 at which the flight(s) are scheduled to close the boarding doors. Depending on the locations of the traveler and of the traveler's luggage, and on the locations of the various earlier departing flight(s), either the transfer time t2 or the transit time t3 may be more restrictive (later) for a given earlier departing flight.

In various embodiments, at 244 the transfer system 104 records in the transfer transactions database 112 at least the following data for each successful ticket transfer: (a) time t at which the traveler selects a ticket for an earlier departing flight; (b) estimated complete transfer time t2 for the earlier departing flight; and (c) actual complete transfer time t4 at which the traveler's luggage is stowed in the earlier departing flight's luggage chamber. Then at 250, the transfer feasibility module 106 can learn a total actual transfer time dt3 from a particular location in a first flight's luggage queue to the luggage chamber of a second flight. Also, at 260 the transit feasibility module 114 can learn a total actual transit time dt4 from a traveler's particular starting location to the gate of a given flight. In the future, the learned times dt3 and dt4 can be used to refine estimates of t2 and t3.

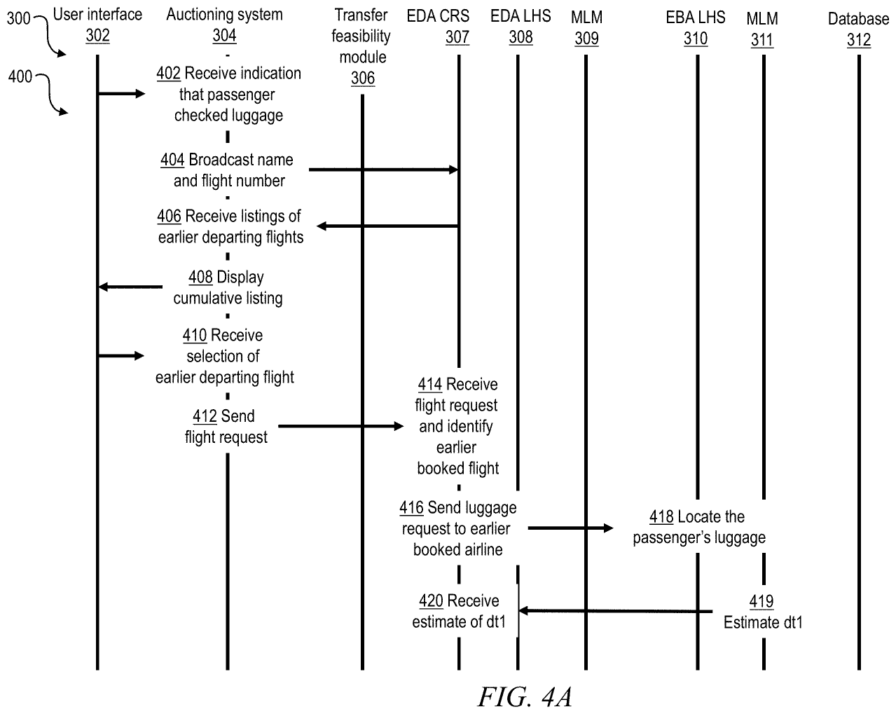

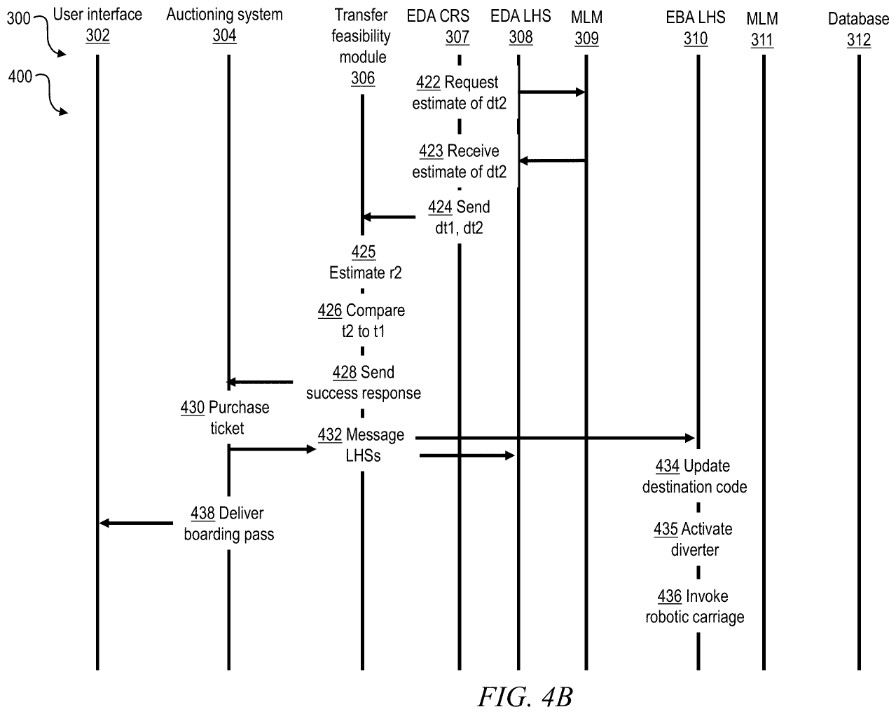

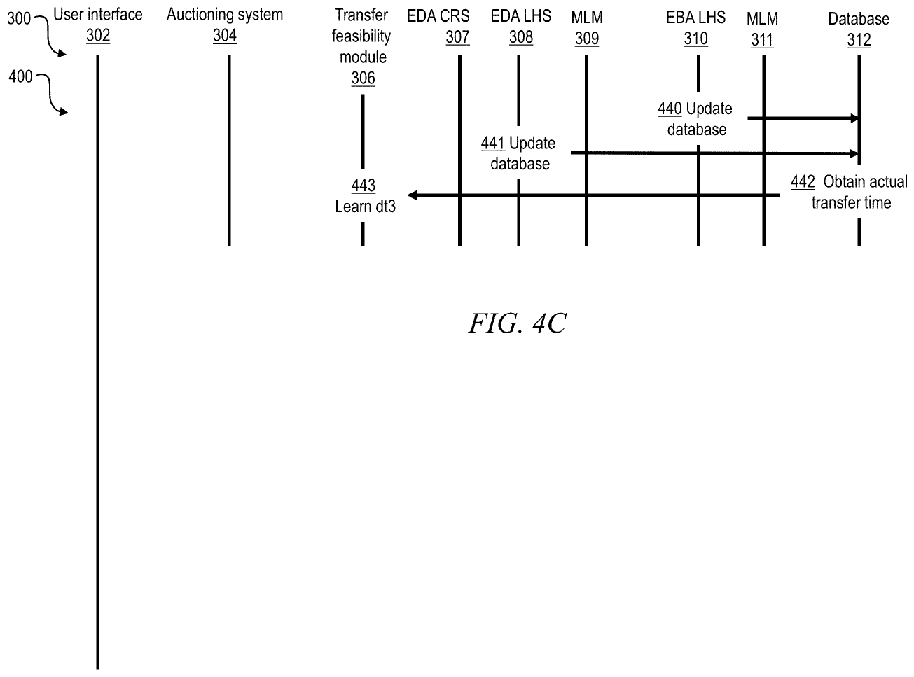

FIGS. 4A-4C depict another system architecture 300 for implementing another method 400 of dynamically moving a flight ticket to an earlier departing flight. The system architecture 300 includes a user interface 302, an transfer system 304, a machine-learning-based transfer feasibility module 306, an earlier departing airline's central reservation system 307, luggage handling system (LHS) 308, and associated machine learning module (MLM) 309, an earlier booked airline's LHS 310 and associated MLM 311, and a transfer transactions database 312.

The method includes, at 402, the transfer system 304 receiving, via the user interface 302, an identification of a traveler and an identification of the traveler's earlier booked flight (e.g., name and flight number). At 404, the transfer system 304 broadcasts the traveler's name and flight number to central reservations systems 307 of a plurality of airlines. At 406, the transfer system 304 receives from each airline a listing of earlier departing flights that have boarding times after the current time and before the boarding time of the traveler's earlier booked flight. At 408, the transfer system 304 displays a cumulative listing of earlier departing flights via the user interface 302. At 410, the transfer system 304 receives from the user interface 302 a selection of an earlier departing flight. At 412, the transfer system 304 sends to the central reservations system (CRS) 307 of the selected (earlier departing) airline a flight request with the traveler's identification (e.g., name), earlier booked flight number, and selected (earlier departing) flight number.

At 414, the selected airline's CRS 307 receives the flight request and identifies the earlier booked airline from the earlier booked flight number. At 416, the selected airline's CRS 307 sends a luggage request to the earlier booked airline's LHS 310; the luggage request includes the traveler's identification, flight number and selected flight number.

At 418, the earlier booked airline's LHS 310 locates the traveler's luggage by scanning for one or more smart tags that match the traveler's identification and flight number, or in other embodiments by searching a database of bar code scan locations and timestamps. In one or more embodiments, the LHS 310 locates the traveler's luggage by communicating with all smart tags (in case of multiple luggage bags) with that traveler identification, and determines the exact locations of the smart tags in the flight luggage chamber or in the luggage queue between a luggage drop point and a luggage chamber. In other embodiments, the LHS 310 locates the traveler's luggage by querying its database of luggage bar code scan locations and time stamps. At 419 the MLM 311 estimates a partial transfer time dt1 to move all of the traveler's luggage to the counter or other luggage drop point for the earlier departing flight from its location(s) in the luggage chamber or elsewhere in the LHS 310. Then at 420 the selected (earlier departing) airline's CRS 307 receives the estimate of dt1 from the earlier booked airline's LHS 310. In “smart tag” embodiments, when the luggage already has been loaded onto the earlier booked flight, the response also includes a picture or diagram of the luggage location in the earlier booked flight's luggage chamber (the luggage location can be used for machine learning module later). Inputs to the MLM include the ground distance between the luggage pick up point from the earlier booked airline to the luggage drop point of the earlier departing airline—which by the way could be simply two points within the airport or two points on the airport ground, or a point in the airport to another point on the airport ground depending upon where the luggage presently is and where it would need to go now if it were to reach the other airline flight. Other inputs include the historical carrying time of luggage between these two points, the present expectation using GPS (global positioning system) if both the points are on the ground, the traffic and obstacle volumes on the path, the likely mode of carrying as historically seen between these two points etc.—and these would be learned by a regression learner to estimate the time to be taken to transfer the luggage.

At 422 the selected (earlier departing) airline's CRS 307 requests from the MLM 309 an estimate of the partial transfer time dt2 for moving the traveler's luggage from the selected airline's luggage drop point to the earlier departing flight's luggage chamber. At 423, the selected airline's CRS 307 receives the estimate of dt2.

As mentioned above, estimates of the partial transfer times dt2, dt1 can be obtained from respective machine learning modules 309, 311 that are associated with respective LHSs 308, 310. Each machine learning module (MLM) can be trained on “big data” from the transfer transactions database 312. For example, each time a luggage transfer is completed, the MLM 311 that is associated with the LHS 310 can obtain from the transfer transactions database 312 an actual time for transferring the luggage from its location in the LHS 310 luggage queue to the counter or other luggage drop point of the LHS 308. The MLM 311 then can compare the actual time to the previously estimated partial transfer time dt1, and can accordingly update the weights of its neural network to bring the estimate of partial transfer time closer to the actual time while keeping other estimated partial transfer times also close to the corresponding actual times. Similarly, the MLM 309 that is associated with the LHS 308 can obtain from the transfer transactions database 312 an actual time for transferring the luggage from the counter or other luggage drop point of the LHS 308 to the luggage chamber of the earlier departing flight. Then the MLM 309 can compare the actual time to the previously estimated partial transfer time dt2, and can accordingly update the weights of its neural network to bring the estimate of partial transfer time closer to the actual time while keeping other estimated partial transfer times also close to the corresponding actual times. Thus, after sufficient repetitions of luggage transfers, each of the MLMs 309, 311 will converge to a model for partial luggage transfer time that predicts the partial transfer time for any given luggage transfer with a satisfactory level of confidence.

At 424 the earlier departing airline sends the partial transfer times dt1 and dt2 to the transfer feasibility module 306. At 425 the transfer feasibility module 306 estimates a complete transfer time t2 to transfer the luggage from earlier booked flight luggage chamber to earlier departing flight luggage chamber by summing up dt1 and dt2 with a current timestamp t. At 426, the transfer feasibility module 306 compares t2 to a known boarding time t1 for the earlier departing flight. If t2 is earlier than t1, then at 428 the transfer feasibility module 306 sends a success response to transfer system 304. In one or more embodiments, t2 should be earlier than t1 by at least a “safety margin” of time; the safety margin can be, for example, five minutes, ten minutes, or twenty minutes.

At 430, if the transfer system 304 has received a success response from the transfer feasibility module 306, then the transfer system 304 purchases for the traveler a standby ticket for the earlier departing flight. Then at 432 the transfer system 304 messages the transfer feasibility module 306, which directs the LHS 310 and the LHS 308 to coordinate luggage transfer from the earlier booked flight to the earlier departing flight. In one or more embodiments, at 434 the earlier booked airline's LHS 310 automatically updates a destination code marked on the traveler's luggage (e.g., applying a new barcode to the luggage or reprogramming the luggage's RFID tag over the air), to indicate the correct earlier departing flight for loading. In one or more embodiments, a flag or sticker is automatically applied to the luggage to indicate that it should be removed from the queue and placed in a different queue. One or more embodiments also include provision and, at 435, activation of diverters within the automated luggage handling system 310, or an alert at a checkpoint within a partially manual LHS, enabling diversion and transfer of the luggage at points between the earlier booked airline's luggage drop and the earlier booked flight's luggage chamber. One or more embodiments also include at 436 invocation of a robotic carriage to transfer the luggage from the earlier booked airline's LHS 310 to the earlier departing airline's LHS 308. At 438, the transfer system 304 delivers to the traveler, via the user interface 302, a boarding pass for the earlier departing flight.

At 440-441, the LHSs 308, 310 update the transfer transactions database 312 with actual transfer times. At 442, the machine-learning-based transfer feasibility module obtains the actual transfer times from the database 312, and at 443, the machine-learning-based transfer feasibility module 306 learns the total time dt3 to transfer the luggage from one airline flight to another airline flight given the luggage locations in other airline flight chamber, time of the day, day of the month, weekend/week-day, crowd in the airport, location of the both airlines chambers, etc. In one or more embodiments, once the transfer feasibility module 306 has sufficiently learned the various transfer times, then instead of relying on the MLMs 309, 311 for estimates of transfer times, the method 400 instead turns to the transfer feasibility module 306. Notably, the transfer feasibility module 306 is distinct from the LHSs 308, 310 and from their respective MLMs 309, 311. Thus, the transfer feasibility module 306 can produce a satisfactorily accurate estimate of completed transfer time t2 from the luggage location data produced by the LHS 308, 310 without relying on the MLMs 309, 311. In one or more embodiments, this may be helpful in case the same flight number may be located at different gates from time to time. Additionally, using a single transfer feasibility module can mitigate time and data costs involved in coordinating between the MLMs of the two different airlines.

In some embodiments, the system can be policy based in its initial stage, wherein once the machine-learning-based transfer feasibility module becomes stable and achieves sufficient accuracy, the time constrained handshaking procedure between two airlines can be omitted such that the system relies on the transfer feasibility module to decide the luggage transfer time.

Additionally, the machine-learning-based transfer feasibility module can be updated periodically (e.g., on a daily basis) with the error in estimated luggage transfer time and actual luggage transfer time.

Thus, one aspect of the invention is a system for dynamically moving a flight ticket to an early flight in the scenario where a customer reaches the airport early for his flight where the on board flight airlines auction their vacant seats. Another aspect is a time constrained transfer of luggage feasibility procedure, which runs between the earlier departing airline and the earlier booked airline, that checks the feasibility of the customer luggage transfer from earlier booked airline to earlier departing airline before the actual boarding of the earlier departing flight starts. Yet another aspect is a machine learning based transfer feasibility module which can learn from historical data the time to transfer luggage from one airline flight's luggage chamber to another airline flight's luggage chamber given customer luggage smart tag data (which precisely tells luggage location in airplane chamber or in luggage queue), time of the day, crowd in the airport, locations of the two luggage chambers, etc.

Given the discussion thus far, and with reference to the accompanying drawings, it will be appreciated that, in general terms, an exemplary method, according to an aspect of the invention, includes at 402 obtaining from a traveler an identification of the traveler and of an earlier booked flight; at 408 providing to the traveler a listing of earlier departing flights; at 410 receiving from the traveler a selection of an earlier departing flight; at 412 identifying an earlier booked airline corresponding to the earlier booked flight, and sending to the earlier booked airline a luggage request; at 428 receiving from a transfer feasibility module a success response to the luggage request, relative to an estimated time for transfer of the traveler's luggage from the earlier booked flight to the selected earlier departing flight; and at 430 completing a purchase for the traveler of a ticket for the selected earlier departing flight.

In one or more embodiments, the step of obtaining an identification of the traveler and of an earlier booked flight is accomplished by an airline ticket transfer system implemented in a cloud configuration distinct from any airline's ticket handling system.

In one or more embodiments, the transfer feasibility module generates the success response based on a machine learning assessment of the estimated time for transfer of the traveler's luggage. For example, the machine learning assessment takes into account a first partial transfer time, which is obtained from a luggage handling system of the earlier booked airline in response to the luggage request. The first partial transfer time is generated by a machine learning module that takes into account a location of the traveler's luggage in the luggage handling system. As another example, the machine learning assessment takes into account a second partial transfer time, which is obtained from a luggage handling system of an earlier departing airline associated with the earlier departing flight. The second partial transfer time is generated by a machine learning module that takes into account a location of the earlier departing flight relative to a luggage drop point of the earlier departing airline.

According to another aspect, an exemplary method includes at 414 receiving from an airline ticket transfer system, at a central reservations system of a selected airline, a flight request that includes a traveler's identification, an earlier departing flight number of the selected airline, and the traveler's earlier booked flight number; at 416 identifying, in the central reservations system of the selected airline, an earlier booked airline based on the earlier booked flight number, and sending to a luggage handling system of the earlier booked airline a first luggage transfer time request that includes the traveler's identification and the traveler's earlier booked flight number; at 420 receiving from the luggage handling system of the earlier booked airline an estimate of a first partial transfer time for transferring the traveler's luggage from its location in the earlier booked airline's luggage system to a luggage drop point of the selected airline; at 422 sending to a luggage handling system of the selected airline a second luggage transfer time request that includes the traveler's identification and the earlier departing flight number; at 423 receiving from the luggage handling system of the selected airline a second partial transfer time to transfer the traveler's luggage from the luggage drop point of the selected airline to a luggage chamber of an earlier departing flight; at 425 obtaining a completed transfer time based on a sum of the first and second partial transfer times with a current time; and at 428, in response to the completed transfer time being earlier than a boarding time of the earlier departing flight, delivering a success message to the transfer system. In one or more embodiments, a transfer feasibility module 306 sends the first and second luggage transfer time requests, receives and sums the first and second partial transfer times, and uses machine learning to obtain the completed transfer time based on the sum of the first and second partial transfer times with the current time. In one or more embodiments, the transfer feasibility module accounts for a location of the traveler's luggage within the luggage handling system of the earlier booked airline and for a location of the selected airline's luggage drop point. In one or more embodiments, the transfer feasibility module accounts for a location of the selected airline's luggage drop point and for a location of the earlier departing flight.

In one or more embodiments, the first partial transfer time is generated by a first machine learning module that is associated with the luggage handling system of the earlier booked airline, wherein the first machine learning module accounts for a location of the traveler's luggage within the luggage handling system of the earlier booked airline and for a location of the selected airline's luggage drop point. In one or more embodiments, the second partial transfer time is generated by a second machine learning module that is associated with the luggage handling system of the selected airline, wherein the second machine learning module accounts for a location of the selected airline's luggage drop point and for a location of the earlier departing flight.

According to another aspect, an exemplary method includes at 420 obtaining from a luggage handling system of a first airline, for a flight ticket transfer transaction, an estimate of a first partial transfer time for transferring a traveler's luggage from its location in a luggage queue of the first airline to a luggage drop point of a second airline; at 423 obtaining from a luggage handling system of the second airline an estimate of a second partial transfer time for transferring the traveler's luggage from the second airline's luggage drop point to a luggage chamber of an earlier departing flight; at 425 estimating an estimated completed transfer time by summing with a current time the estimates of the first and second partial transfer times; at 442 obtaining from a transfer transactions database an actual completed transfer time for the flight ticket transfer transaction; and at 443 training a machine learning module to estimate another completed transfer time for another flight ticket transfer transaction, based on comparing the actual completed transfer time to the estimated completed transfer time.

In one or more embodiments, the machine learning module is trained to account for a location of a traveler's luggage associated with the other flight ticket transfer transaction and to account for a location of a luggage drop point of a selected airline associated with the other flight ticket transfer transaction. In one or more embodiments, the machine learning module is trained to account for a time of day at which the other flight ticket transfer transaction is requested. In one or more embodiments, the machine learning module is trained to account for a date at which the other flight ticket transfer transaction is requested. In one or more embodiments, the machine learning module is implemented in a cloud distinct from any airline's ticketing system. In one or more embodiments, the steps of obtaining and estimating are implemented in a transfer feasibility module distinct from the machine learning module. In one or more embodiments, the machine learning module is associated with a luggage handling system of an airline.

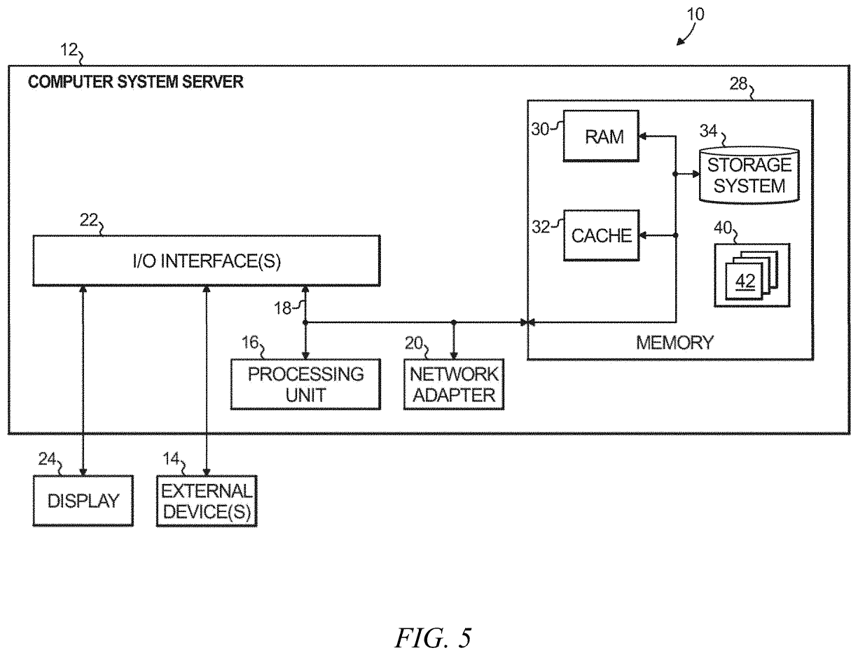

One or more embodiments of the invention, or elements thereof, can be implemented in the form of an apparatus including a memory and at least one processor that is coupled to the memory and operative to perform exemplary method steps, or in the form of a non-transitory computer readable medium embodying computer executable instructions that when executed by a computer cause the computer to perform exemplary method steps. FIG. 5 depicts a computer system that may be useful in implementing one or more aspects and/or elements of the invention, also representative of a cloud computing node according to an embodiment of the present invention. Referring now to FIG. 5, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 5, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 5) running a server program. It will be understood that such a physical server may or may not include a display and keyboard.

One or more embodiments can be at least partially implemented in the context of a cloud or virtual machine environment, although this is exemplary and non-limiting.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining an identification of a traveler and of an earlier booked flight;
providing a listing of earlier departing flights;
receiving a selection of an earlier departing flight from among the listing of the earlier departing flights;
identifying an earlier booked airline corresponding to the earlier booked flight, and sending to the earlier booked airline a luggage request;
receiving from a transfer feasibility module a success response to the luggage request, relative to an estimated time for transfer of the traveler's luggage from the earlier booked flight to the selected earlier departing flight; and
completing a purchase of a ticket for the selected earlier departing flight.

2. The method of claim 1, wherein the step of obtaining an identification of the traveler and of an earlier booked flight is accomplished by an airline ticket transfer system implemented in a cloud configuration distinct from any airline's ticket handling system.

3. The method of claim 1, wherein the transfer feasibility module generates the success response based on a machine learning assessment of the estimated time for transfer of the traveler's luggage.

4. The method of claim 3, wherein the machine learning assessment takes into account a first partial transfer time, which is obtained from a luggage handling system of the earlier booked airline in response to the luggage request, wherein the first partial transfer time is generated by a machine learning module that takes into account a location of the traveler's luggage in the luggage handling system.

5. The method of claim 3, wherein the machine learning assessment takes into account a second partial transfer time, which is obtained from a luggage handling system of an earlier departing airline associated with the earlier departing flight, wherein the second partial transfer time is generated by a machine learning module that takes into account a location of the earlier departing flight relative to a luggage drop point of the earlier departing airline.

6. The method of claim 1, further comprising facilitating removing the traveler's luggage from a luggage handling system of the earlier booked airline by activating a diverter within the luggage handling system.

7. The method of claim 1, further comprising facilitating marking the traveler's luggage with an updated destination code.

8. A method comprising:
receiving from an airline ticket transfer system, at a central reservations system of a selected airline, a flight request that includes a traveler's identification, an earlier departing flight number of the selected airline, and the traveler's earlier booked flight number;
identifying, in the central reservations system of the selected airline, an earlier booked airline based on the earlier booked flight number;
sending to a luggage handling system of the earlier booked airline a first luggage transfer time request that includes the traveler's identification and the traveler's earlier booked flight number;
receiving from the luggage handling system of the earlier booked airline an estimate of a first partial transfer time for transferring the traveler's luggage from its location in the earlier booked airline's luggage system to a luggage drop point of the selected airline;
sending to a luggage handling system of the selected airline a second luggage transfer time request that includes the traveler's identification and the earlier departing flight number;
receiving from the luggage handling system of the selected airline a second partial transfer time to transfer the traveler's luggage from the luggage drop point of the selected airline to a luggage chamber of an earlier departing flight;
obtaining a completed transfer time based on a sum of the first and second partial transfer times with a current time; and
in response to the completed transfer time being earlier than a boarding time of the earlier departing flight, delivering a success message to the transfer system and initiating a transfer of the traveler's luggage from the earlier booked airline's luggage handling system to the selected airline's luggage handling system.

9. The method of claim 8, wherein a transfer feasibility module sends the first and second luggage transfer time requests, receives and sums the first and second partial transfer times, and uses machine learning to obtain the completed transfer time based on the sum of the first and second partial transfer times with the current time.

10. The method of claim 9, wherein the transfer feasibility module accounts for a location of the traveler's luggage within the luggage handling system of the earlier booked airline and for a location of the selected airline's luggage drop point.

11. The method of claim 9, wherein the transfer feasibility module accounts for a location of the selected airline's luggage drop point and for a location of the earlier departing flight.

12. The method of claim 8, wherein the first partial transfer time is generated by a first machine learning module that is associated with the luggage handling system of the earlier booked airline, wherein the first machine learning module accounts for a location of the traveler's luggage within the luggage handling system of the earlier booked airline and for a location of the selected airline's luggage drop point.

13. The method of claim 8, wherein the second partial transfer time is generated by a second machine learning module that is associated with the luggage handling system of the selected airline, wherein the second machine learning module accounts for a location of the selected airline's luggage drop point and for a location of the earlier departing flight.

14. A method comprising:
obtaining from a luggage handling system of a first airline, for a flight ticket transfer transaction, an estimate of a first partial transfer time for transferring a traveler's luggage from its location in a luggage queue of the first airline to a luggage drop point of a second airline;
obtaining from a luggage handling system of the second airline an estimate of a second partial transfer time for transferring the traveler's luggage from the second airline's luggage drop point to a luggage chamber of an earlier departing flight;
estimating an estimated completed transfer time by summing with a current time the estimates of the first and second partial transfer times;
obtaining from a transfer transactions database an actual completed transfer time for the flight ticket transfer transaction; and
training a machine learning module to estimate another completed transfer time for another flight ticket transfer transaction, based on comparing the actual completed transfer time to the estimated completed transfer time.

15. The method of claim 14, wherein the machine learning module is trained to account for a location of a traveler's luggage associated with the other flight ticket transfer transaction and to account for a location of a luggage drop point of a selected airline associated with the other flight ticket transfer transaction.

16. The method of claim 14, wherein the machine learning module is trained to account for a time of day at which the other flight ticket transfer transaction is requested.

17. The method of claim 14, wherein the machine learning module is trained to account for a date at which the other flight ticket transfer transaction is requested.

18. The method of claim 14, wherein the machine learning module is implemented in a cloud distinct from any airline's ticketing system.

19. The method of claim 14, wherein the steps of obtaining and estimating are implemented in a transfer feasibility module distinct from the machine learning module.

20. The method of claim 14, wherein the machine learning module is associated with a luggage handling system of an airline.
